(19) United States
(12) Patent Application Publication
(10) Pub. No.: US 2008/0258927 A1
(43) Pub. Date: Oct. 23, 2008

(54) MONITORING DEVICE FOR MOTHERBOARD VOLTAGE

(75) Inventors: YING CHEN, Shenzhen (CN); JIN-LIANG XIONG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/838,903

(22) Filed: Aug. 15, 2007

(30) Foreign Application Priority Data
Apr. 18, 2007 (CN) 200710200482.5

(51) Int. Cl. G08B 21/18; G08B 5/36

(52) U.S. Cl. 340/661; 327/88

(57) ABSTRACT

An embodiment of a device for monitoring voltages of a motherboard includes: a comparator having an input terminal connected to a reference voltage and the other input terminal connected to a voltage of the motherboard; an electrical switch having a first terminal connected to an output terminal of the comparator, a second terminal connected to a power source, and a third terminal being grounded; and a light emitting diode (LED) including a cathode connected to the second terminal of the electrical switch and an anode connected to the power source. The electrical switch is turned on when the first terminal of the electrical switch receives a controlling signal from the comparator. Then the LED emits light to show an abnormal state of the voltage of the motherboard.

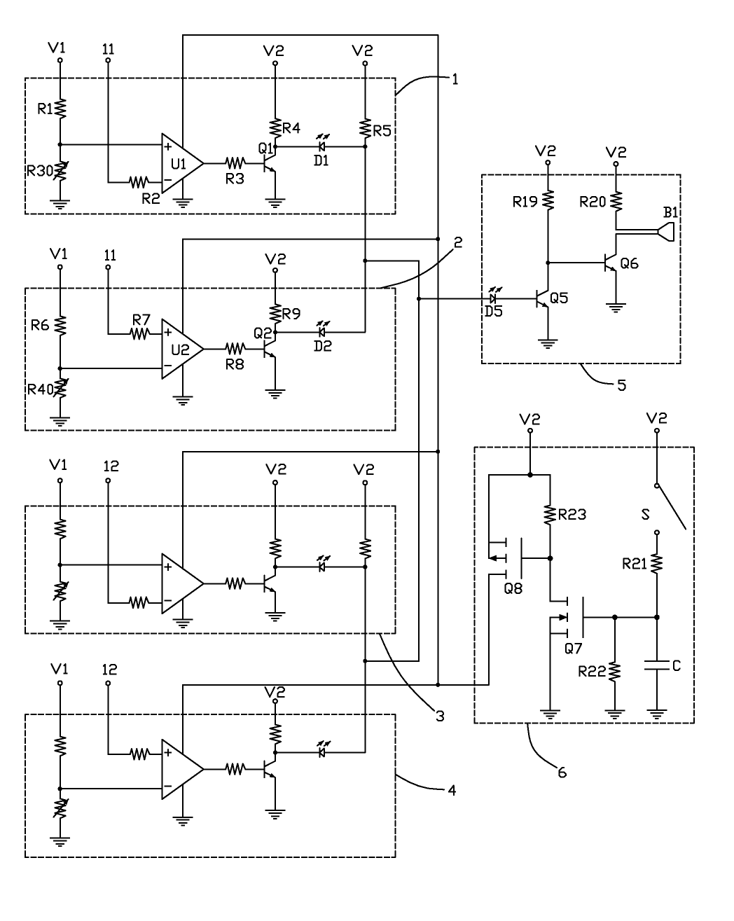

### CROSS REFERENCE

This application is related to a copending application entitled with “VOLTAGE MONITORING DEVICE”, filed on the same date, and assigned to the same assignee.

### BACKGROUND

1. Field of the Invention

The present invention relates to monitoring devices, and particularly to a monitoring device for monitoring voltages of a motherboard.

2. Description of Related Art

In a computer system, a power supply provides power to the motherboard. The motherboard then provides the power at certain voltages such as +5V, −5V, +3.3V, +12V, −12V and so on to chipsets or circuits on the motherboard. However, if any of the voltages provided by the motherboard becomes too high, the chipsets or circuits may be damaged or if the voltage provided by the motherboard is too low, the chipsets or circuits may be unable to operate properly.

### SUMMARY

An embodiment of a device for monitoring voltages of a motherboard includes: a voltage circuit to provide a reference voltage; a comparator having a positive input terminal to receive the reference voltage (or receive a voltage provided by the motherboard), a negative input terminal to receive the voltage provided by the motherboard (or receive the reference voltage), and an output terminal to output a control signal when the voltage provided by the motherboard is lower (or higher) than the reference voltage; a first electrical switch having a first terminal connected to the output terminal of the comparator, a second terminal connected to a power source, and a third terminal being grounded; an indicator connected to the first electrical switch to warn when the first electrical switch is turned on by the control signal; and a delay circuit connected between the power source and a power terminal of the comparator to delay the comparator from working.

Other advantages and novel features will become more apparent from the following detailed description when taken in conjunction with the accompanying drawing, in which:

### BRIEF DESCRIPTION OF THE DRAWINGS

The drawing is a circuit diagram of one embodiment of a device for monitoring voltages of a motherboard in accordance with the present invention.

### DETAILED DESCRIPTION

Referring to the drawing, a device for monitoring voltages of a motherboard in accordance with an embodiment of the present invention includes four test units 1˜4, an alarm unit 5, and a delay unit 6. The test units 1 and 2 are used to test a voltage 11 provided by the motherboard. The test units 3 and 4 are used to test another voltage 12 provided by the motherboard. The alarm unit 5 gives an alarm when the voltage 11 or 12 is out of a voltage range.

The test unit 1 includes resistors R1˜R5, a variable resistor R30, a comparator U1, an NPN transistor Q1 functioning as an electrical switch, and a luminous diode D1.

The resistor R1 and the variable resistor R30 are connected in series between a first power source V1 and ground to form a voltage circuit, a reference voltage is generated across the variable resistor R30. The comparator U1 has a positive input terminal + to receive the reference voltage, a negative input terminal − to receive the voltage 11 provided by the motherboard via the resistor R2, and an output terminal to output a control signal when the voltage 11 is lower than the reference voltage. A base of the transistor Q1 is connected to the output terminal of the comparator U1 via the resistor R3, a collector of the transistor Q1 is connected to a second power source V2 via a resistor R4, and an emitter of the transistor Q1 is grounded. An anode of the luminous diode D1 is connected to the second power source V2 via the resistor R5 and a cathode of the luminous diode D1 is connected to the collector of the transistor Q1.

The test unit 1 is used to test a lower limit of the voltage 11 provided by the motherboard. The reference voltage is set to be a standard lower limit of the voltage 11 by adjusting the variable resistor R30. The comparator U1 will output a high level voltage to turn on the transistor Q1 when the voltage 11 is lower than the reference voltage, and the luminous diode D1 is turned on.

The test unit 2 includes resistors R6˜R9, a variable resistor R40, a comparator U2, an NPN transistor Q2 functioning as an electrical switch, and a luminous diode D2.

The resistor R6 and the variable resistor R40 are connected in series between the first power source V1 and ground to form a voltage circuit, a reference voltage is generated across the variable resistor R40. The comparator U2 has a positive input terminal + to receive the voltage 11 provided by the motherboard via the resistor R7, a negative input terminal − to receive the reference voltage, and an output terminal to output a control signal when the voltage 11 is higher than the reference voltage. A base of the transistor Q2 is connected to the output terminal of the comparator U2 via the resistor R8, a collector of the transistor Q2 is connected to a second power source V2 via a resistor R9, and an emitter of the transistor Q2 is grounded. An anode of the luminous diode D2 is connected to the second power source V2 via the resistor R5 and a cathode of the luminous diode D2 is connected to the collector of the transistor Q2.

The test unit 2 is used to test an upper limit of the voltage 11 provided by the motherboard. The reference voltage is set to be a standard upper limit of the voltage 11 by adjusting the variable resistor R40. The comparator U2 will output a high level voltage to turn on the transistor Q2 when the voltage 11 is higher than the reference voltage, and the luminous diode D2 is turned on.

The test unit 3 is the same as the test unit 1 but for testing a lower limit of the voltage 12 provided by the motherboard, and the test unit 4 is same as the test unit 2 but for testing an upper limit of the voltage 12 provided by the motherboard.

In this exemplary embodiment, the alarm unit 5 includes two resistors R19 and R20, two NPN transistors Q5 and Q6, a luminous diode D5, and a buzzer B1. An anode of the luminous diode D5 is connected to the anodes of the luminous diodes D1˜D4, and a cathode of the luminous diode D5 is connected to a base of the transistor Q5. A collector of the transistor Q5 is connected to the second power source V2 via the resistor R19 and to a base of the transistor Q6, and an emitter of the transistor Q5 is grounded. A collector of the transistor Q6 is connected to the second power source V2 via the buzzer B1 and the resistor R20, and an emitter of the transistor Q6 is grounded.

The luminous diode D5 is turned off when any one of the luminous diodes D1,D2 of the units 1˜4 is turned on. Thereby, the transistor Q5 is turned off, the transistor Q6 is turned on, and the buzzer B1 is turned on to give an alarm.

The delay unit 6 includes an N-channel MOSFET Q7, a P-channel MOSFET Q8, three resistors R21˜R23, a capacitor C, and a switch S. The switch S, resistor R21, and capacitor C are connected in series between the second power source V2 and ground to provide a drive voltage at a node between the resistor R21 and the capacitor C. A gate of the MOSFET Q7 is connected to the node between the resistor R21 and the capacitor C, a drain of the MOSFET Q7 is connected to the second power source V2 via the resistor R23, and a source of the MOSFET Q7 is grounded. A gate of the MOSFET Q8 is connected to the drain of the MOSFET Q7, a drain of the MOSFET Q8 is connected to the second power source V2, and a source of the MOSFET Q8 is connected to power terminals of the comparators U1 and U2. The resistor R22 is connected between the node and ground.

When the switch S is turned on, the MOSFET Q7 is turned on after a delay time caused by the capacitor C, and then the MOSFET Q8 is turned on to transmit the power source V2 to the comparators U1 and U2 of the units 1˜4. When the switch is turned off, electrical energy on the capacitor C is released via the resistor R22. The delay unit 6 delays power to the comparators U1 and U2 to make sure that the voltage 11 provided by the motherboard is steady when the comparators U1 and U2 are turned on.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A device for monitoring voltages of a motherboard, comprising:
a voltage circuit to provide a reference voltage;
a comparator having a positive input terminal to receive the reference voltage, a negative input terminal to receive a voltage provided by the motherboard, and an output terminal to output a control signal when the voltage provided by the motherboard is lower than the reference voltage;
a first electrical switch having a first terminal connected to the output terminal of the comparator, a second terminal connected to a power source, and a third terminal being grounded, wherein the first electrical switch is turned on when receiving the control signal;
an indicator connected to the first electrical switch to gave an alarm when the first electrical switch is turned on; and
a delay circuit connected between the power source and a power terminal of the comparator to delay the comparator from receiving a starting voltage.

2. The device as claimed in claim 1, wherein the voltage circuit includes a resistor and a variable resistor connected in series between another power source and ground, the reference voltage is a voltage adjusted across the variable resistor.

3. The device as claimed in claim 1, wherein the first electrical switch is an NPN transistor.

4. The device as claimed in claim 1, wherein the delay circuit includes a second electrical switch, a third electrical switch, a first resistor, a second resistor, a capacitor, and a switch, wherein the switch, first resistor, and capacitor are connected in series between the power source and ground to provide a drive voltage on a node between the first resistor and the capacitor, the second electrical switch has a first terminal connected to the node, a second terminal connected to the power source, and a third terminal be grounded, the third electrical switch has a first terminal connected to the second terminal of the second electrical switch, a second terminal connected to the power source, and a third terminal connected to the power terminal of the comparator, the second resistor is connected between the node and ground.

5. The device as claimed in claim 4, wherein the second electrical switch is an N-channel MOSFET, and the third electrical switch is a P-channel MOPSFET.

6. The device as claimed in claim 1, wherein the indicator is an LED having an anode connected to the power source and a cathode connected to the second terminal of the first electrical switch.

7. An device for monitoring voltages of a motherboard, comprising:
a voltage circuit to provide a reference voltage;
a comparator having a positive input terminal to receive a voltage provided by the motherboard, a negative input terminal to receive the reference voltage, and an output terminal to output a control signal when the voltage provided by the motherboard is higher than the reference voltage;
a first electrical switch having a first terminal connected to the output terminal of the comparator, a second terminal connected to a power source, and a third terminal being grounded, wherein the first electrical switch is turned on when receiving the control signal;
an indicator connected to the first electrical switch to give an alarm when the first electrical switch is turned on; and
a delay circuit connected between the power source and a power terminal of the comparator to delay the comparator from receiving a starting voltage.

8. The device as claimed in claim 7, wherein the voltage circuit includes a resistor and a variable resistor connected in series between another power source and ground, the reference voltage is a voltage across the variable resistor.

9. The device as claimed in claim 7, wherein the first electrical switch is a NPN transistor.

10. The device as claimed in claim 7, wherein the delay circuit includes a second electrical switch, a third electrical switch, a first resistor, a second resistor, a capacitor, and a switch, wherein the switch, first resistor, and capacitor are connected in series between the power source and ground to provide a drive voltage on a node between the first resistor and the capacitor, the second electrical switch has a first terminal connected to the node, a second terminal connected to the power source, and a third terminal be grounded, the third electrical switch has a first terminal connected to the second terminal of the second electrical switch, a second terminal connected to the second power source, and a third terminal connected to the power terminal of the comparator, the second resistor is connected between the node and ground.

11. The device as claimed in claim 10, wherein the second electrical switch is an N-channel MOSFET, and the third electrical switch is a P-channel MOPSFET.

12. The device as claimed in claim 7, wherein the indicator is an LED having an anode connected to the power source and a cathode connected to the second terminal of the first electrical switch.

13. An device for monitoring voltages of a motherboard, comprising:
a first voltage circuit to provide a first reference voltage;
a first comparator having a positive input terminal to receive a voltage provided by the motherboard, a negative input terminal to receive the first reference voltage, and an output terminal to output a first control signal when the voltage provided by the motherboard is higher than the first reference voltage;
a first electrical switch having a first terminal connected to the output terminal of the first comparator, a second terminal connected to a power source, and a third terminal being grounded, wherein the first electrical switch is turned on when receiving the first control signal;
a second voltage circuit to provide a second reference voltage;
a second comparator having a negative input terminal to receive the voltage provided by the motherboard, a positive input terminal to receive the second reference voltage, and an output terminal to output a second control signal when the voltage provided by the motherboard is lower than the second reference voltage;
a second electrical switch having a first terminal connected to the output terminal of the second comparator, a second terminal connected to the power source, and a third terminal being grounded, wherein the second electrical switch is turned on when receiving the second control signal; and
an alarm unit connected to the first and second electrical switches to give an alarm when the first or second electrical switch is turned on.

14. The device as claimed in claim 13 further including a delay circuit connected between the power source and a power terminal of each comparators to delay the comparators from receiving a starting voltage.
